(19) United States
(12) Patent Application Publication
(10) Pub. No.: US 2019/0299557 A1
(43) Pub. Date: Oct. 3, 2019

(54) CONTAINERS

(71) Applicant: Leslie John Skinner, Tullamarine (AU)

(72) Inventor: Leslie John Skinner, Tullamarine (AU)

(73) Assignee: ICEE Holdings Unit Trust, ICEE Holdings Pty. Ltd., Trustee, Melbourne (AU)

(21) Appl. No.: 16/292,768

(22) Filed: Mar. 5, 2019

Related U.S. Application Data
(62) Division of application No. 13/262,813, filed on Oct. 3, 2011, now abandoned.

(51) Int. Cl. B31D 1/00; B29C 65/00; B29C 65/58; B29C 44/08; B29C 53/06; B29C 65/56; B65D 85/34; B65D 1/22; B29C 44/04

(52) U.S. Cl. CPC B31D 1/0043; B29C 37/0057; B29C 65/58; B29C 44/08; B29C 53/063; B29C 66/4326; B29C 66/549; B29C 66/53461; B29C 66/542; B29C 65/56; B29C 65/562; B65D 85/34; B65D 1/225; B29C 66/727; B29C 66/71; B29C 66/54; B29C 44/0446; B29C 66/1162

(57) ABSTRACT

A blank for a box made from an expandable material, which is initially molded to be substantially flat and in which folds forming hinges are to be made to enable the formation of the box. The tooling defines the shape of the blank is such as to provide a thickness of the expanded material that is less than the thickness of a major portion of the blank, in which folds are to be made having defined edges, generally in the direction of each fold; the fold and subsequently applying pressure along an area where folds are to be permitted to reduce the blank are made without removing material therefrom for providing hinges to permit formation of the box. A related method for making the blank and a box that is made from the blank are further provided.

### TECHNICAL AREA

This invention relates to improvements in containers and particularly to containers which are made from polystyrene pellets or other expandable or foamable materials, hereinafter referred to as expandable materials.

### BACKGROUND TO THE INVENTION

For many years polystyrene boxes (as they will be referred to herein although boxes of other expandable materials could be used), have been used for transport of many articles of example agricultural and horticultural products and specifically fruit and vegetables, aquacultural products, such as fish, processed goods such as pharmaceuticals and these boxes are directly moulded into the required end shape.

To effect moulding of polystyrene, pellets of the material are placed in a mould and then steam is introduced into the mould and the steam causes the pellets to expand so that they both merge with each other and coalesce and, at the same time fully occupy the mould. Such moulding can provide articles which are dimensionally exact.

These boxes have been perfectly satisfactory in use, but have had the major disadvantage that they are moulded in one piece and occupy a very high volume for their weight and are thus most inefficient to transport empty. This has necessitated, on occasions, having box-making factories located at or near the site where they are to be used and has also limited the possibility of re-use of these boxes.

From an environmental point-of-view this means that after use these boxes were generally simply broken down and placed in land-fill and there was substantial expense in this.

There have previously been proposed polystyrene boxes which can be made from flat blanks, for example, in the present applicant's PCT patent application PCT/AU2007/000693. These, whilst having certain advantages, have also not been fully successful in operation.

### Outline of the Invention

It is the object of the present invention to provide new forms of polystyrene boxes which minimise problems which previously have occurred and which substantially opens the usage area for such boxes.

The Invention Includes a blank for a box made from an expandable material which is initially moulded generally flat in which, where folds forming hinges are to be made adjacent the junctions between the base of the box and the sides and ends thereof to enable the formation of the box, the tooling which defines the shape of the blank is such as to provide a thickness of the expanded material less than the thickness of the major part of the blank wherein the area of less thickness having defined edges generally in the direction of each fold the fold and subsequently applying pressure along the area where folds are to be made to reduce the thickness of the this blank without removing material therefrom thereby providing hinges to permit formation of the box.

In one aspect of the invention, the portion of the tooling which defines the areas where the folds are to be made have sides which are directed inwardly and a flat portion at the junction of the sides and wherein the pressure to reduce the thickness and form the hinge is provided by a tool which has an outer part which corresponds to the equivalent portion of the tooling used during moulding to provide the defined edges and an inner part which is generally a continuation of the defined edges to cause the reduction of the thickness.

It may be preferred the formation of the hinges is done shortly after the formation of the blank whilst the blank contains water condensed from the steam used in the moulding process. The initial formation of the blank and the formation of the hinges are done in two separate steps.

It is preferred that where portions of the box are to abut that they either be formed in the mould at an angle to provide two surfaces which can closely abut to form a mitre joint when the boxes in its required position.

It is a feature of the invention that on at least one side of the blank there can be located a film of water-impervious material which provides a waterproof box. If the film is on the inner side of the box, it can be coloured or the like to enable the box to act as a display member and when, on the outer side of the film, may provide a box with a surface which can be aesthetically attractive. It is also possible to print or emboss the film to enhance this situation.

The invention also includes a method of forming the blank comprising the steps of providing a tool having two components which overlay each other and define the outer shape of the blank the components being provided with members which, where folds are to be made, extend further toward the centre of the blank than the for the remainder of the blank, delivering an expandable material into the tool and effecting expansion thereof to form the initial blank, placing the formed blank into another tool similar to the first tool but in which the members where folds are to be made extend further into the area between the tool component and applying pressure to the tool so that the members where folds are to be made reduce the thickness of the blank without removing material therefrom to form a hinge.

The invention also includes a box using the blank of the invention.

In order that the invention may be more readily understood certain embodiments of boxes made in accordance with the invention will be described in relation to the accompanying drawings, in which.

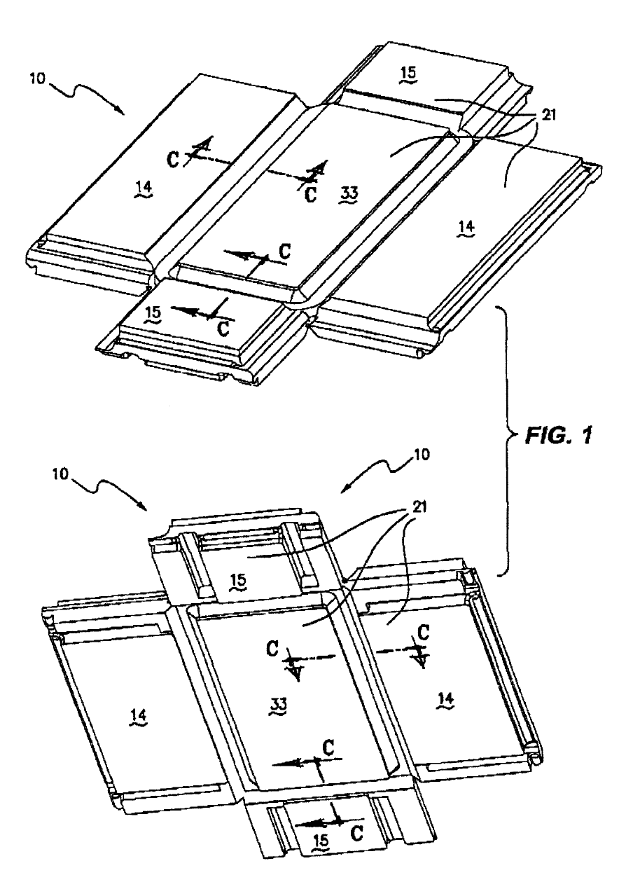

FIG. 1 Shows the blank of the invention as delivered from the first moulding step;

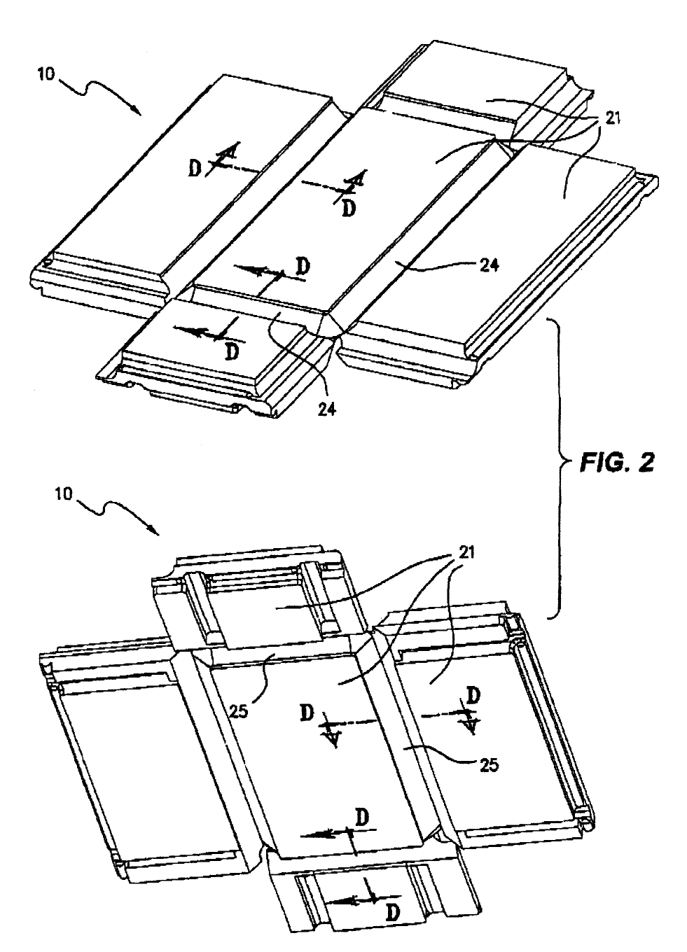

FIG. 2 Shows the complete blank after the second step in the manufacture has been applied thereto;

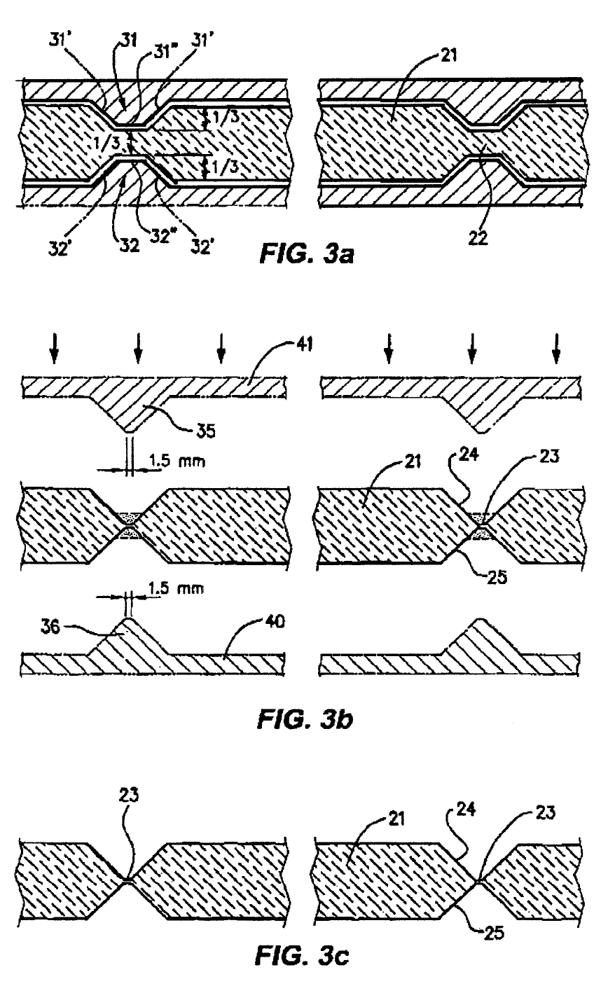

FIG. 3a is a section along C-C of FIG. 1 showing the initial formation of the blank where hinges are to be formed;

FIG. 3b is a section along D-D of FIG. 2 showing the formed hinges after the second step is completed;

FIG. 3c is a section of the box after completion of the formation process;

FIG. 4 shows a box assembled from the blank of FIG. 2 and using a particular clip arrangement to retain the box in this useable condition;

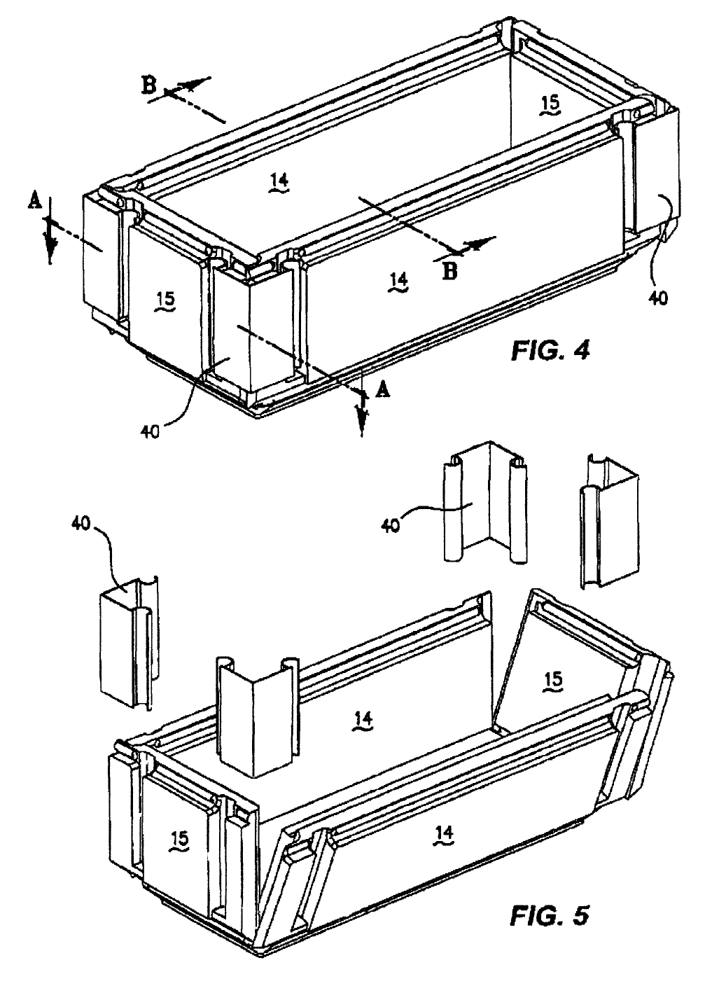

FIG. 5 shows the box of FIG. 4 with the clips removed and the sides and ends not completely folded;

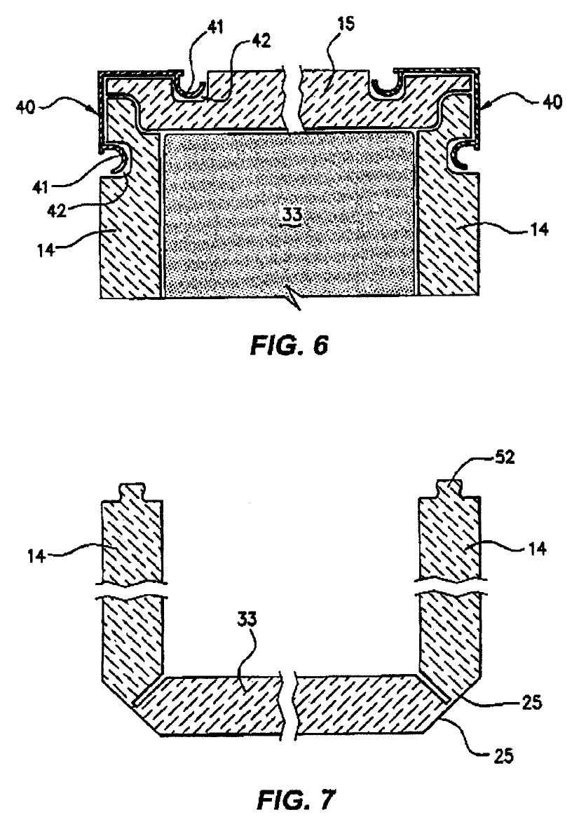

FIG. 6 is a cross section along line A-A of FIG. 4;

FIG. 7 is a cross section along line B-B of FIG. 4;

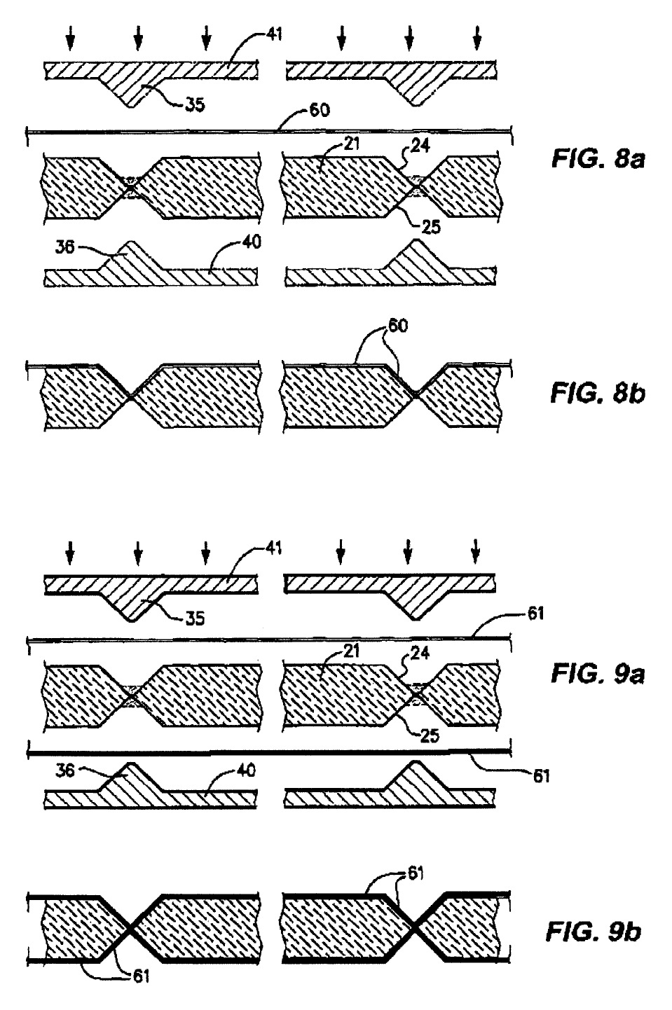

FIGS. 8a and 8b are views similar to FIGS. 3b and 3c showing the location of a film on one side of the blank;

FIGS. 9a and 9b are views similar to FIGS. 8a and 8b showing films on each side of the blank;

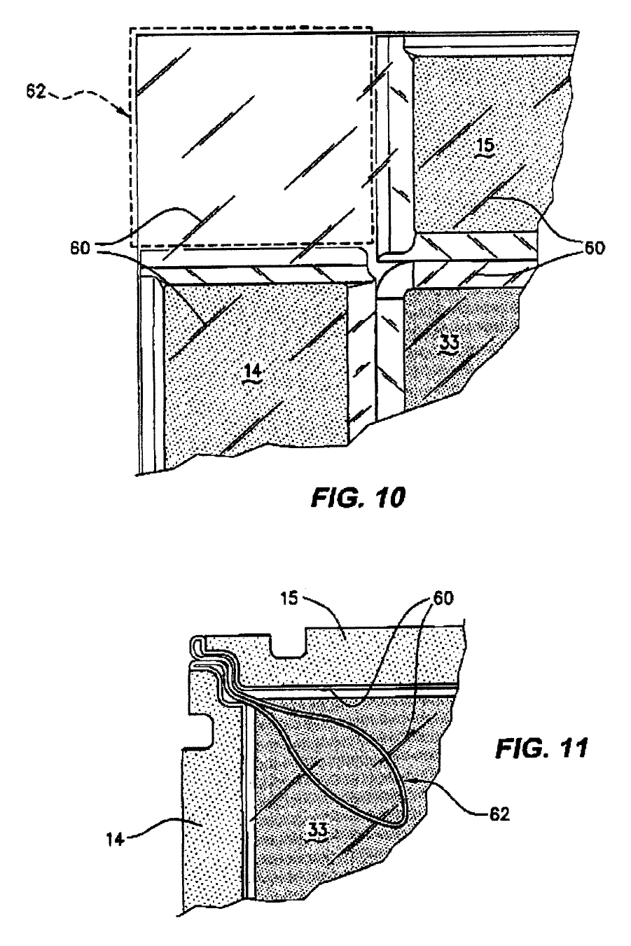

FIG. 10 is a plan view of part of the blank of FIG. 8b showing the film extending over the area between an adjacent side an end of the blank of the invention;

FIG. 11 is a plan view of part of a completed box showing how this portion of the film extends into the box;

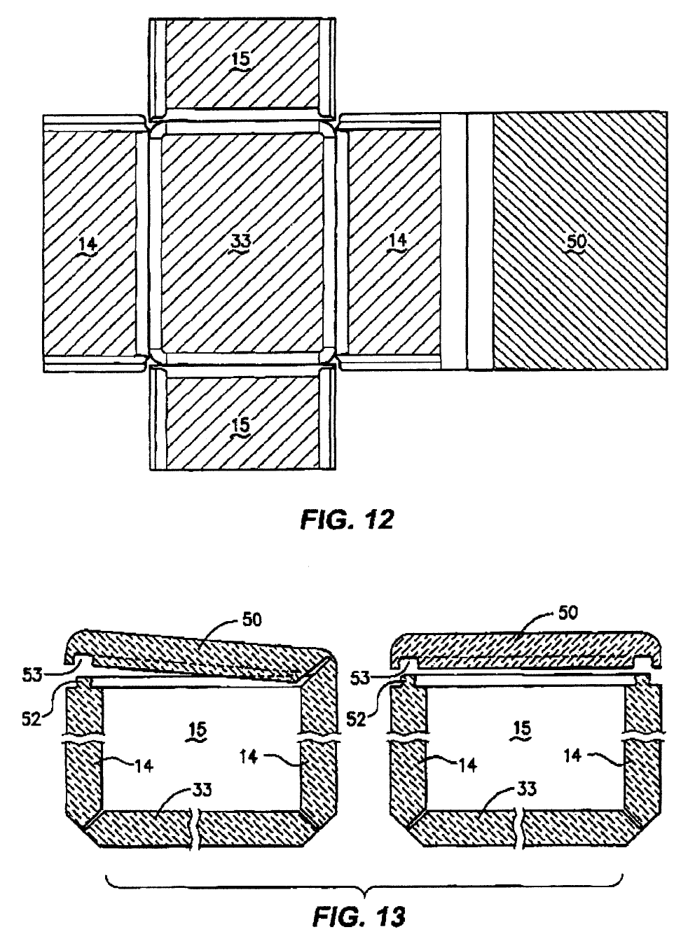

FIG. 12 shows a blank generally similar to the blank of FIG. 2 which enables a box to be formed with an integral lid; and

FIG. 13 is a view showing the closure of the integral lid and also a closure which could be used with lids separate from the box.

### DESCRIPTION OF AN EMBODIMENT OF THE INVENTION

As mentioned above, the box is formed by providing, from a mould, a flat blank of expanded or other suitable expandable material which, in the simplest form, has an area 21 which will comprise the base and four areas extending outwardly therefrom to provide the sides 14 and the ends 15, characterised that the fold-lines to permit the sides and ends to be rotated around the base are provided by linear members within the tooling.

The formation of the blank 10 is a two step process.

In the first step there is a two piece mould which is the negative of the blanks of FIG. 1 and into this tool there is introduced pellets or beads of polystyrene and steam which causes the beads to soften, expand and coalesce to fill the mould. Depending on the density required from the completed box, so the quantity and grade of pellets introduced will vary. This technique is well known in the art.

As can be seen from FIG. 3a where the hinges are to be formed, there are incursions 31,32 on the tools which extend into the space defined by the tool and which extend the length of the associated side or end.

These incursion are each approximately ⅓ of the depth of the expanded material 21 which forms the blank, leaving approximately ⅓ of the thickness of the body of the blank 21 remaining.

The incursions have side walls 31′,32′ which are at angles to the mould which walls, if extended, would terminate close to the centre of the blank but have flat faces 31″ and 32″ at their inner ends. As the blank closely abuts the die when expanded, these side walls and flat faces are accurately formed.

The blank of FIG. 1 is then placed into a die which again has two components and which, apart from the form of the incursions 35,36 is effectively identical to the mould in which the blank was originally formed.

One of the die members 40 is fixed and the blank of FIGS. 1 and 2 is placed on the die member 40 and the other die member 41 is moved down over the blank and the incursions 35, 36 cause compression of the part 22 of the blank until it adopts the position shown in FIG. 3b. That is, the part 22 of the blank is deformed until it forms a hinge 23 and, as can be seen from this figure, as the incursions 35,36 are at the same angle as those 31,32 the completed deformation is continuous from the partial formation from the first die. This can be seen from the dotted portions in FIG. 3b. It will be appreciated that the amount of material in the hinge is the same as the material 22, that is that this is compressed without any loss of material which forms a strong web of material at 23, and thus a strong hinge.

It is preferred that this second step takes place shortly after the blank is moulded in the first step and preferably whilst it is warm to hot and contains a substantial amount of water from the steam which caused the expansion of the pellets of expandable material. Whilst not shown, but which is well known in the art, there can be steam relief holes in the tooling so that excess steam and water can pass therefrom.

It is believed that pressure is the main causative agent for the blank to adopt its final shape but this can be assisted by heat and moisture both of which are or can be present during the second formation.

As mentioned above, the areas where two members are to be brought together the portions 31′ and 32′ are formed very accurately in the initial moulding step to provide clean edges and the formation after the second step continues this angle to the position of the hinge.

When the adjacent members are rotated towards each other, as can be seen from FIGS. 5 and 6, the sides 14 and ends 15 are adapted to abut and form a right angled mitre joint. The similar arrangement on the side away from this causes the external angle at the junction of the two members to be neat and to form effectively a planar surface within the overall confines of the box. This can best be seen from FIG. 7.

If the assembled box is to be rectangular, which is the most usual shape, or square, the formations about which rotation occur can be substantially at 45° to each other and the portion adjacent the flat portions of the two members have a sharp return to provide a good abutment of the members when they are brought into position. Again, this can best be seen from FIG. 7.

Depending on the requirements for the completed box, the angles of connection can vary.

One aspect of forming a blank flat as described herein enables great flexibility in designing a blank, and thus a box, which can be designed for a particular purpose some of which are described herein.

For example a flat blank enables variations in thickness of parts of the blank, for example areas where the full strength of the box made from the blank may not be required thus saving material in the blank. Also, the various sides and ends can be contoured to save material. Further, the blank can be used to provide optimum protection for shaped articles.

Further undercuts can be made which can readily be removed from the mould which is generally not possible for one piece boxes.

It can also permit the manufacture of boxes which have curved sides or which may have shapes which are impossible for one piece mouldings, such as boxes which are triangular in section in which the angles formed by the areas adjacent the hinges can depart from right angles, such as included angles being at 60°.

Because the thickness of the portion 23 about which the turning moment is provided is less, than the remainder of the box due in part to the compression during the formation of the hinge, then the rotation is relatively easy.

Referring to FIGS. 4 and 5, FIG. 4 shows a completed box made from the blank of the previous figures. The sides 14 and ends 15 are rotated upwardly until they abut. In this particular embodiment there are used clips 40 which are angle members and which have at each end an extension 41 which is adapted to enter a recess 42 in the outer surface of the box which recesses are formed during the initial moulding operation previously described. The clips 40 may be of metal or plastics material which can be deformed whilst being fitted into the recesses and resile to their initial shape after fitting.

The box can be assembled as shown in FIGS. 4, 5 and 6 and it can be used to carry products. Although not illustrated in these figures, a lid which is complementary to the top of the box can be located either over the top or within the top and the lid can be sealed by use of an adhesive tape or the like. When the contents have been removed from the box, it is only necessary to remove the clips 40 and the sides and ends can be opened to, once again provide a flat blank as described earlier herein.

If required, the top of the box could be provided with a formation 52, shown in FIGS. 7 and 13, which is adapted to co-operate with a complementary formation 53 on the underside of the lid, shown in FIG. 13 to firmly retain the lid in position. The formation could, as illustrated be of a mushroom shape which can readily be removed from the mould.

Such blanks can readily be stacked and transported for reuse or some other use or, if necessary, they can be placed in a waste container or tip. Generally with expanded plastics boxes, they are not reused as the cost of transport is substantial as only relatively few boxes can be carried on or in any form of transport so they are normally broken down and treated as waste.

Further the clips illustrated are, as stated above purely exemplary. However it will be appreciated that clips which are relatively short will work fully satisfactorily and full height clips can be used if the boxes are to be stacked as they can give the box strength, particularly where the clips are directly above each other.

Instead of clips of the type shown there are many other ways of holding the box assembled. For example adhesive tape can be placed around the various corners or a strap or the like can be passed around the periphery of the box. If boxes are not to be reused, and it will be noted that this is still advantageous in that many more blanks can be delivered by a particular method than completed boxes, then they could be adhesively secured together prior to use.

It Is also possible to provide the clips to extend effectively the total height of the box and for their upper ends to be adapted to receive and co-operate with the lower end of the clip of an adjacent box located therebeneath or thereabove so that the clips can effectively provide spacers or pillars to permit adjacent boxes to be located one above the other whilst ensuring there will be little pressure from one box onto the adjacent box. It this way the contents, should they be pastry or the like, are basically protected against any damage from crushing.

Whilst the use of clips of this type and these provide a good structural arrangement, they may be less than fully satisfactory in some applications, for example, where the box is a reusable box which needs to be readily dissembled for storage and reassembled for packing and delivery of product but without separate components. This could be particularly useful, in, say, pastry applications as discussed above where the products are generally made at a position spaced from the point of sale and have to be delivered in a way that there is minimal damage to the product.

In a case such as this, there may be used different forms of assembly of the box. Firstly, it could simply be held together by a long band of a flexible elastic or a non-elastic material which can be passed around the periphery of the completed box. This band may be connected by means of a readily adjustable buckle or the like, it may be formed from a strip having Velcro (Registered Trade Mark) components thereon so that the box can be held in its extended position simply by wrapping the strip around the box and interconnecting the two Velcro components.

Again, these members could comprise a first Velcro member including a strap attached to an end or side and a second Velcro member attached to the side or end so that by simply moving this strap around the corner and connecting the Velcro components the box is maintained in its extended position but when it is to be transported the Velcro connections can simply be separated and the box let lie flat.

Alternatively, it could be done by having members attached to one of the adjacent members, say a side or an end, which members are adapted to pass around the corner and be connected to the adjacent side of the box.

Further, as discussed earlier herein the top of the box can be provided with a formation which is complementary with a formation on a lid and this combination can also be used in maintaining the box in its assembled condition. It is desirable that the lid is secured to the box by adhesive tape, or in some other manner to avoid inadvertent removal of the lid and thus the possibility that the integrity of the box would be destroyed.

If a box with an integral closure is required then during the initial moulding, as shown in FIG. 12, there is an extension 50 from the outer edge of one of the sides 35 which extension has a size equivalent to the top of the box and which may have a peripheral formation 53 which can co-operate with extensions 52 about the periphery of the box, and as previously described, retain the lid in position and secure it to the box

Because the blank during the first step is formed within a mould it is possible to form the mould to provide particular descriptive or other material embossed into or extending from the surface of the box.

It will be appreciated that for ease of manufacture it is preferred that the material extend beyond the normal surface of the box, as this necessitates only the removal of metal from the mould to correspond to the required information. If it is preferred that the material be inserted into the surface of the box, it is preferred that die inserts are provided to provide the required information, as this necessitates the removal of far less metal than would be the case if effectively the whole of the die surface had to be removed.

In the embodiments of FIGS. 8 and 9 before the second step in formation of the blank, a plastics film 60 can be located over the surface of the blank, either as illustrated in FIG. 8 on that area which will be inside the box or the area which will be the outside the box, or both, as illustrated in FIG. 9.

The film may be coated with an adhesive, such as a layer of urethane material, and when this is laid over the blank, the film overlying these is moved into the incursions 24 and provides a full coverage of the surface of the blank.

Where the film is on the inner surface of the blank, as illustrated in FIG. 8 it may be preferred that it has dimensions to overly the whole of the blank, including the cut-out portions as shown as 62 which separate the sides 14 and ends 15. When the box is formed then the portion of film 62 can be folded into the interior or exterior of the box so there is a continuous film membrane making the box waterproof. If required the portion of film 62 could be sealed to itself or the film on the interior of the box to ensure no possibility of leakage.

If a film is used on the outer surface this may be a pre-printed film which includes details of the supplier of the contents, possibly the contents themselves, and any other statutory material which is required, together with advertising material, if desired.

The film on the inner side can simply be a transparent film or if, for example, the container is to be used for display purposes, it could be a coloured film or even one which has a pattern or printing thereon.

Where the film has a heat activated adhesive on it, it is desirable to simply apply a small amount of heat possibly by way of applying steam to the top side of the film which heat assists in bonding the heat activated adhesive to the blank surface.

Film could be applied to both surfaces of the blank, as illustrated in FIG. 9 so the benefits obtained by having smooth, possibly decorative surfaces both on the outside and the inside of the box and a liquid tight box. In this case, the film on the outer surface should be provided with a plurality of air bleed holes as the blank after formation, and as described earlier herein, has a substantial quantity of water derived from the steam which expanded the pellets of expandable material and this must be permitted to escape. Films on both sides of the blank are particularly desirable if the blanks after use and after being opened need to be cleaned or sterilized.

It can be seen that the box of the invention can take many different forms and sizes, all using the basic concept of a flat moulded assembly which has formed thinner portions where hinging is to occur and the box of the invention can also be used for many different applications, for example, where an internal film lining is provided, the carriage of fish or other material which has a quantity of liquid associated therewith by air may be possible.

The provision of a film lining also permits the ready cleaning and/or sterilizing the dissembled blank between uses and particularly where the use it to change.

A box which can be readily dissembled and reassembled is very useful for short-run delivery where the box occupies only a necessary amount of space when including the contents, but can be knocked down to enable back loading. A particular application is the delivery of pastry items which are baked at distance from the point of sale.

Whilst we have found that the hinges formed in the blank have a substantial life where a box is to be reused, we have found that for boxes which are to be used a large number of times, a layer of film on one side or the other of the box gives not only the advantages as previously mentioned but also gives the narrowed hinge portion additional strength, so that even after a substantial number of assemblies and dis-assemblies there is little likelihood of the polystyrene at the point of connection of the two components fracturing.

It is also possible to use the film to provide a tamper evident seal between the lid and the body of the box by extending the film from at least one side of the body and then securing this to the lid, when fitted, by the use of the adhesive on the underside of the film which can be activated by heat or in some other way, to adhere to the lid. This can also act as a closure to retain the lid in position.

Whilst in this specification there has been described several forms of boxes made in accordance with the invention, it is to be appreciated that these are exemplary only and modifications can be made without departing from the spirit and scope of the invention.

1-26. (canceled)

27. A process for forming a blank for a box made from an expandable material, comprising the steps of:
molding a blank to be substantially flat with at least one hinge being formed by adjacent junctions between a base of a box and sides and ends thereof for forming a fold for enabling formation of the box via the base, the sides and the ends, the blank being formed in a first step wherein an expandable material is caused to expand within a tool configuration defining a shape of the blank, the at least one hinge of the blank being defined by a portion of said tool configuration that provides an area of the blank having a thickness less than the thickness of a major portion of the blank, the hinges having defined edges substantially in direction of each fold, and wherein the at least one hinge is further formed by a second step by applying pressure to the blank at the at least one hinge for further reducing the thickness of the blank in the at least one hinge, without removing material therefrom.

28. The process for forming a blank for a box made from an expandable material according to claim 27, wherein the portion of said tool configuration defining the at least one hinge of the blank has sides directly inwardly and a flat portion at the adjacent junction of the sides for providing the defined edges of the at least one hinge.

29. The process for forming a blank for a box made from an expandable material according to claim 28, wherein the second step comprises applying pressure at said at least one hinge by an additional tool configuration having an outer part corresponding to the portion of said tool configuration defining said at least one hinge in said first step and an inner part which is substantially a continuation of the defined edges for causing said further reduction of thickness of the blank in said at least one hinge.

30. The process for forming a blank for a box made from an expandable material according to claim 29, wherein said tool configuration and said additional tool configuration are separate tools.

31. The process for forming a blank for a box made from an expandable material according to claim 27, wherein the first step occurs after the formation of the blank in the first step.

32. The process for forming a blank for a box made from an expandable material according to claim 27, wherein during formation of the blank in the first step, the expandable material expands through an application of steam and an application of pressure to the blank is applied in the second step while the blank contains water condensed from the steam used in the first step.

33. The process for forming a blank for a box made from an expandable material according to claim 27, wherein during said second step, temperature, in addition to said pressure, is applied to the blank at the said at least one hinge.

34. The process for forming a blank for a box made from an expandable material according to claim 27, further comprising the step of applying a film to the blank on at least one surface thereof prior to said second step.

35. The process for forming a blank for a box made from an expandable material according to claim 34, wherein the film is applied to two surfaces of the blank prior to said second step.

36. The process for forming a blank for a box made from an expandable material according to claim 34, wherein the film has an adhesive provided thereon to facilitate application of the film to the surface of the blank.

37. A blank for a box made of an expandable material, the blank made by a process comprising the steps of:
molding a blank to be substantially flat with at least one hinge being formed by adjacent junctions between a base of a box and sides and ends thereof for forming a fold for enabling formation of the box via the base, the sides and the ends, the blank being formed in a first step wherein an expandable material is caused to expand within a tool configuration defining a shape of the blank, the at least one hinge of the blank being defined by a portion of said tool configuration that provides an area of the blank having a thickness less than the thickness of a major portion of the blank, the hinges having defined edges substantially in direction of each fold, and wherein the at least one hinge is further formed by a second step by applying pressure to the blank at the at least one hinge for further reducing the thickness of the blank in the at least one hinge, without removing material therefrom.

38. A box formed from a blank made by a process comprising the steps of:
molding a blank to be substantially flat with at least one hinge being formed by adjacent junctions between a base of a box and sides and ends thereof for forming a fold for enabling formation of the box via the base, the sides and the ends, the blank being formed in a first step wherein an expandable material is caused to expand within a tool configuration defining a shape of the blank, the at least one hinge of the blank being defined by a portion of said tool configuration that provides an area of the blank having a thickness less than the thickness of a major portion of the blank, the hinges having defined edges substantially in direction of each fold, and wherein the at least one hinge is further formed by a second step by applying pressure to the blank at the at least one hinge for further reducing the thickness of the blank in the at least one hinge, without removing material therefrom.
